(19) United States
(12) Patent Application Publication
(10) Pub. No.: US 2011/0289671 A1
(43) Pub. Date: Dec. 1, 2011

(54) PROTECTIVE FOAM BARRIER FOR USE IN LATRINE STORAGE TANKS

(76) Inventor: Benjamin M. Westrick, Fort Wayne, IN (US)

(21) Appl. No.: 13/112,787

(22) Filed: May 20, 2011

Related U.S. Application Data
(60) Provisional application No. 61/348,380, filed on May 26, 2010.

(51) Int. Cl. A47K 11/04; B05B 17/00

(52) U.S. Cl. 4/476; 239/1

(57) ABSTRACT

An extended-duration foam may be used to entrap and suppress waste deposited into a latrine storage tank. The foam floats on a liquid or solid surface to form a protective barrier between the waste material stored in the latrine storage tank and the indoor atmosphere of the latrine. When liquid or solid material is deposited into the storage tank having the foam layer, the waste material passes through the foam and into the liquid and/or solid layer of waste material beneath the foam. The foam “self repairs” after the material passes therethrough, maintaining an effective visual and olfactory barrier between the waste material and the latrine atmosphere.

### CROSS-REFERENCE TO RELATED APPLICATIONS

This application claims the benefit under 35 U.S.C. §119(e) of U.S. Provisional Patent Application Ser. No. 61/348,380 filed May 26, 2010 and entitled PROTECTIVE FOAM BARRIER FOR USE IN LATRINE STORAGE TANKS, the entire disclosure of which is hereby expressly incorporated herein by reference.

### BACKGROUND

1. Technical Field

The present disclosure relates to latrines and portable toilets and, in particular, to a protective foam between the user of a latrine and waste material contained in a latrine storage container.

2. Description of the Related Art

Temporary or permanent restroom facilities with drainable waste storage tanks (i.e., “latrines”) are commonly utilized at sites where it would be impractical to construct or maintain a conventional restroom with municipal sewage system service. Examples of such sites include parks and recreational facilities, construction sites, camp sites, military installations, disaster areas, and anywhere without access to a municipal sewage system or commercial septic tank. These restroom facilities typically include storage tanks which must be regularly drained or pumped out into a waste-hauling vehicle, which then hauls the waste to a remote location for proper disposal. In some instances, an entire portable latrine with a full storage tank is exchanged for a clean portable latrine, and the full storage tank is drained at the remote location.

During the interval between storage tank drainages, waste material builds up in the latrine storage tank. The waste buildup may be unsightly, may produce unpleasant odors, and/or may attract unwanted insects to the latrine, for example. In addition, the storage tank waste presents a potential health hazard for latrine users, such as if waste material splashes out of the latrine storage tank during latrine use.

While frequent cleaning of the latrine storage tank may ameliorate some problems associated with latrine storage tanks, frequent cleaning may be impractical or prohibitively expensive, particularly in latrines located in remote areas. To minimize the proliferation of odor and other problems between cleanings, scented and/or disinfectant sanitizing chemicals are sometimes added to the latrine storage tanks. These chemicals suffer from the same splash-back potential described above, and may offer only a minimal level of protection against odors and unsightly waste buildup, particularly where cleaning intervals are long.

Accordingly, substantial design efforts have focused on systems and methods to increase the safety and usability of latrines between storage tank drainages.

### SUMMARY

The present disclosure provides an extended-duration foam which may be used to entrap and suppress waste deposited into a latrine storage tank. The foam floats on a liquid or solid surface to form a protective barrier between the waste material stored in the latrine storage tank and the indoor atmosphere of the latrine. When liquid or solid material is deposited into the storage tank having the foam layer, the waste material passes through the foam and into the liquid and/or solid layer of waste material beneath the foam. The foam “self repairs” after the material passes therethrough, maintaining an effective visual and olfactory barrier between the waste material and the latrine atmosphere.

Advantageously, the foam retains its “reparability” and sensory barrier properties for an extended time, such as several days or multiple weeks. The protective foam barrier of the present disclosure thus provides an inexpensive and effective method and apparatus for maintaining a suitable environment in an enclosed latrine between storage tank drainages.

In one form thereof, the present disclosure provides a method of isolating a user of a latrine from waste material contained in a latrine storage tank, the latrine having an interior sized to accommodate the user of the latrine, the method comprising: forming a protective foam barrier within the latrine storage tank, the latrine storage tank in fluid communication with the interior of the latrine, the foam barrier providing at least one of an olfactory barrier, a visual barrier, and a physical barrier against splash back of waste material.

In another form thereof, the present disclosure provides a method of servicing a portable latrine, the method comprising: providing a portable latrine having a latrine storage tank adapted to receive and store waste material; forming a protective foam barrier within the latrine storage tank, the foam barrier providing at least one of an olfactory barrier, a visual barrier, and a physical barrier against splash back of waste material; and delivering the portable latrine to a service site.

In yet another form thereof, the present disclosure provides a latrine comprising: a toilet; a latrine storage tank in fluid communication with the toilet; a protective foam barrier formed in the latrine storage tank, the protective foam barrier comprised of a plurality of self-repairing bubbles that are slidably oriented adjacent one another, such that the protective foam barrier allows waste material to pass therethrough while also providing at least one of an olfactory barrier, a visual barrier, and a physical barrier against splash back of waste material.

### BRIEF DESCRIPTION OF THE DRAWINGS

The above-mentioned and other features and advantages of this disclosure, and the manner of attaining them, will become more apparent and the invention itself will be better understood by reference to the following description of embodiments of the invention taken in conjunction with the accompanying drawings, wherein:

FIG. 1 is a perspective view of a portable latrine with an internal storage tank, illustrating a protective foam barrier in the storage tank;

FIG. 2 is an elevation, section view of a portion of the portable toilet shown in FIG. 1, illustrating the latrine storage tank with waste material and a protective foam barrier formed on the waste material;

FIG. 3 is an elevation, section view of a non-portable latrine with an underground storage tank, illustrating a protective foam barrier formed on a layer of waste material at the bottom of the storage tank;

FIG. 4 is a schematic diagram illustrating a system for delivering foam to a latrine storage tank;

FIG. 5 is an elevation, section view of a hand-held foam delivery system for delivering foam to a latrine storage tank; and

FIG. 6 is a flow chart illustrating an exemplary method of forming a protective foam barrier in accordance with the present disclosure.

Corresponding reference characters indicate corresponding parts throughout the several views. The exemplifications set out herein illustrate exemplary embodiments of the invention, and such exemplifications are not to be construed as limiting the scope of the invention in any manner.

### DETAILED DESCRIPTION

### 1. Protective Foam and Method of Use

The present disclosure provides systems and methods for forming a protective foam barrier in a latrine storage tank, in which the foam barrier protects latrine users from unpleasant sights and smells and minimizes or eliminates the potential for waste material splashing out of the latrine storage tank during latrine use. The protective foam barrier is self-repairing, in that the foam layer acts to fill the void formed by waste materials passing through the protective foam barrier. The protective foam barrier may have an effective service life of multiple days or weeks, thereby providing the above-mentioned and other benefits for long intervals between periodic drainage and cleaning of a latrine storage tank.

As used herein, “latrine” refers to a toilet or toilet structure that is at least partially enclosed and is in fluid communication with a latrine storage tank or container located in the interior of the enclosure. The latrine storage tank and toilet are typically accessible by a door. The latrine storage tank is primarily adapted to contain human excrement, though other waste materials may intermix with the human excrement (such as if the latrine is misused as a trash receptacle). The latrine storage tank is often adapted to be periodically emptied or drained for permanent disposal of the contained waste.

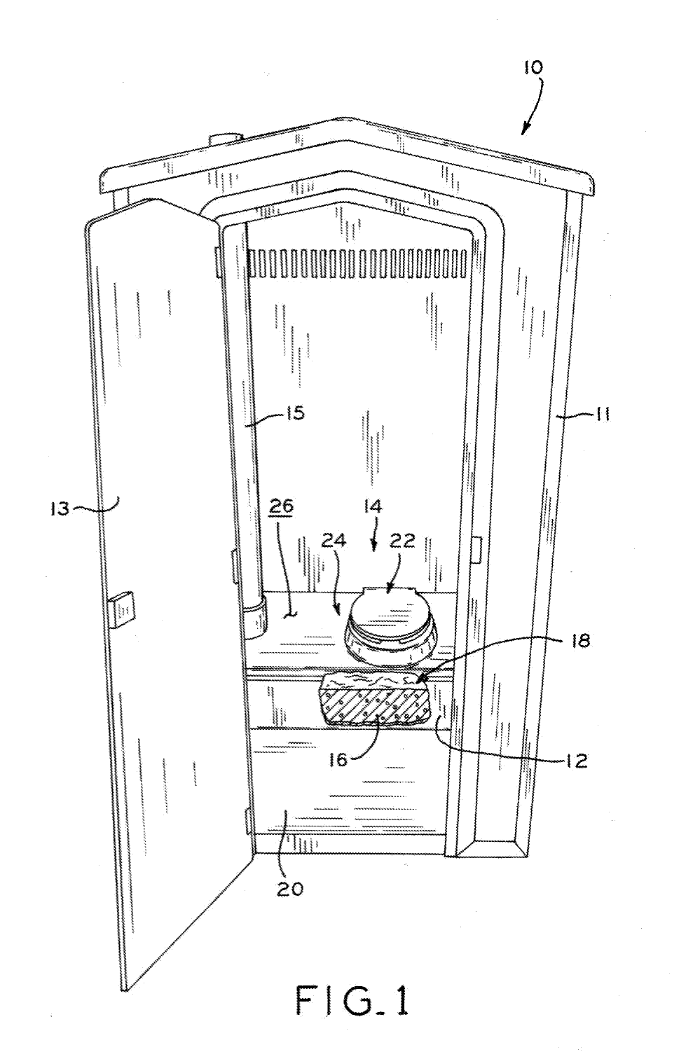

Turning now to FIG. 1, portable latrine 10 includes enclosure 11 at least partially enclosing storage tank 12 formed underneath toilet 14. Toilet 14 and storage tank 12 are located within the interior of enclosure 11, and are user-accessible via door 13. Enclosure 11 is sized to substantially enclose storage tank 12, toilet 14 and a user of latrine 10, though enclosure 11 may have vents (not shown) or other openings in fluid communication with the air outside of enclosure 11. Storage tank 12 may also be vented to the outside air, such as by vent pipe 15.

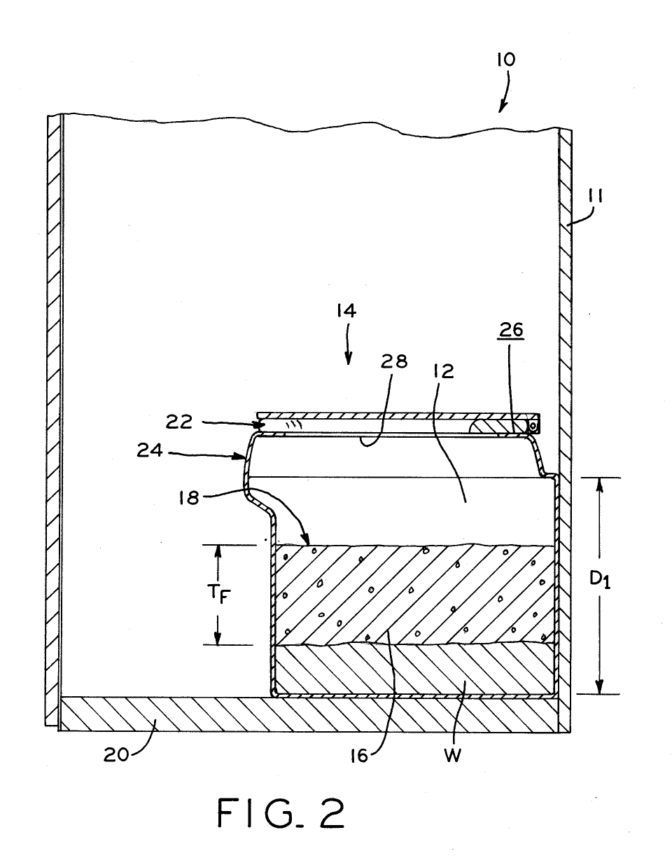

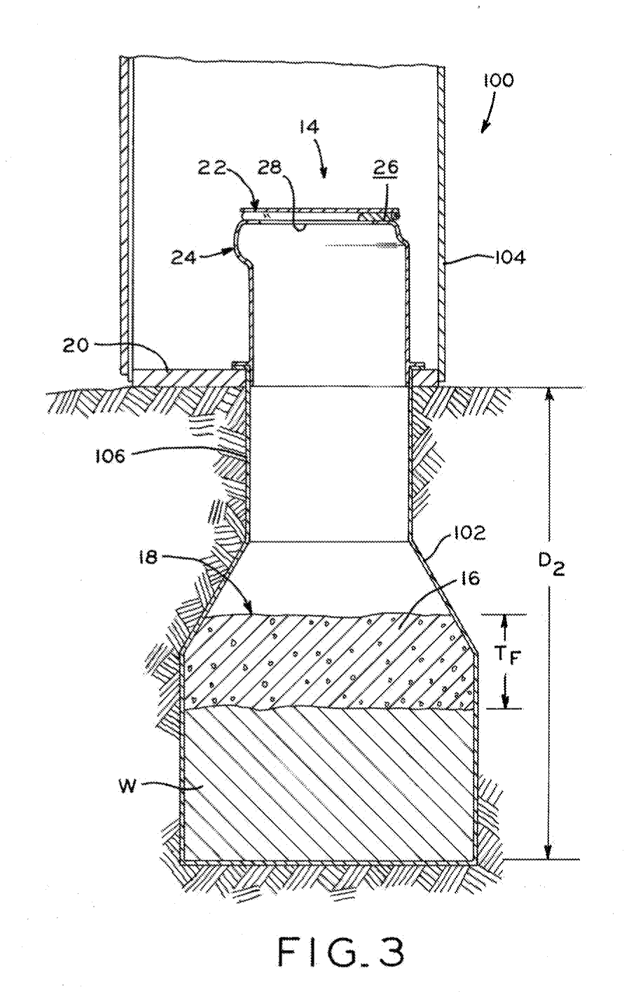

Toilet 14 includes seat/cover assembly 22, housing 24 having seat support surface 26, and aperture 28 (FIG. 2) formed in housing 24 adjacent seat assembly 22. Housing 24 may form a portion of storage tank 12, as shown in FIG. 2, or may be a conduit to a subterranean storage tank 102 (FIG. 3, discussed below). In the illustrative embodiment of FIG. 1, storage tank 12 does not contain any liquid or solid waste, indicating that portable latrine 10 either has not been used or has not been used since storage tank 12 was previously drained (i.e., during a periodic latrine servicing procedure). In preparation for latrine use, and as described in detail below, storage tank 12 is partially filled with foam 16 to form protective foam barrier 18 beneath toilet 14. When toilet 14 is in use, liquid and/or solid waste material, such as human excrement, passes through foam 16 to collect at the bottom of storage tank 12 beneath protective foam barrier 18 to form a layer of waste material W beneath protective foam barrier 18 (FIG. 2).

Optionally, storage tank 12 may also include a liquid sanitizing material (not shown) intended to mix with waste material entering storage tank 12. If such sanitizing material is used, protective foam barrier 18 is disposed between toilet 14 and the sanitizing material (i.e., the foam sits on top of the liquid sanitizing material). Excrement passes through protective foam 16 and into the sanitizing material, so that the waste material W is a mix of excrement and sanitizing material. However, the use of foam barrier 18 in storage tank 12 advantageously allows for the use of little or no liquid sanitizing material. Without foam barrier 18, several inches of sanitizing material might be used to ensure complete coverage of waste material W even when storage tank 12 is nearly full. On the other hand, foam barrier 18 may be provided with thickness T_{F} (FIG. 2) regardless of the quantity of waste material W, because foam barrier is elevated above waste material W as storage tank 12 becomes full (rather than mixing with waste material W).

After waste material passes through foam 16, the resulting void in protective foam barrier 18 is quickly closed by foam 16 shifting from adjacent areas to seal off and close the void. In addition, as described in detail below, foam barrier 18 can perform this sealing of voids for an extended length of time. Thus, foam 16 may be referred to as a “persistent” foam, in that disruptions to protective foam barrier 18 do not result in any significant discontinuity extending through protective foam barrier 18 because adjacent volumes of foam 16 will quickly and continuously migrate into the disrupted area to maintain foam barrier continuity.

This foam persistence is, in part, a function of a characteristic of foam 16 which may be referred to as “reparability”, i.e., the ability of foam bubbles to slide with respect to one another, so that a low friction interface between adjacent foam bubbles facilitates rapid relocation of bubbles to a newly created void via gravitational forces. Thus, when a material passes through protective foam barrier 18, some bubbles of foam 16 will be ruptured, while others will migrate to the periphery of the void created by the material as it passes through barrier 18. Once the material has completed its passage past a given area of barrier 18, however, the bubbles of foam 16 adjacent to the newly created void will quickly slide over one another at the low friction interface between respective bubbles and “fall in” to the newly created void. In this way, the continuity of protective foam barrier 18 is substantially uncompromised by material passing through foam 16.

In an exemplary embodiment, foam 16 may be formed from a surfactant, or “super detergent” material that creates a rich lather of very small bubbles when pressurized and agitated. For example, one particular surfactant suitable for use in accordance with the present is an aqueous foam composition disclosed in U.S. Pat. No. 4,874,641, filed Nov. 24, 1987, the entire disclosure of which is hereby incorporated herein by reference. This particular foam composition is available from Rusmar Incorporated, of West Chester, Pa., and is described in the material safety data sheet for “long duration foam AC-645”, a copy of which is filed on even date herewith as Exhibit A, the entire disclosure of which is hereby incorporated herein by reference. Advantageously, the AC-645 foam does not require the use of respiratory protection, ventilation, protective gloves or eye protection, therefore rendering the foam suitable for use in a latrine environment. In addition, the AC-645 foam is completely biodegradable and can be disposed of in a sanitary landfill according to local regulations.

Other foams having similar persistence and visual, olfactory and/or physical splash barrier properties may be used within the spirit and scope of the present disclosure. Suitable high-stability foams, such as foams having stabilizing additives, are disclosed in U.S. Pat. Nos. 3,422,011 (filed May 3, 1966), 4,127,383 (filed Jun. 10, 1977) and 5,434,192 (filed Feb. 2, 1993), the entire disclosures of which are hereby expressly incorporated herein by reference. Another suitable high-stability foam is AFT-400 foam available from Allied Foam Tech Corp. of Montgomeryville, Pa.

Referring now to FIG. 2, storage tank 12 has depth D₁, which is typically dictated by the desired height of toilet 14 and the height or thickness of floor 20 of enclosure 11 surrounding tank 12 and toilet 14. Unlike a permanent latrine installation (such as shown in FIG. 3, and discussed in detail below), storage tank 12 of portable latrine 10 does not extend below floor 20 of portable latrine 10, thereby allowing portable latrine 10 to be installed at or removed from any desired location without significant preparation of the latrine service site. In certain exemplary embodiments, interior depth D₁ of storage tank 12 is about 17 inches from the bottom inside surface of storage tank 12 to the bottom of seat 22 of toilet 14. This relatively shallow depth potentially places the upper surface of waste material W relatively near toilet 14, raising the possibility of waste material splashing on the user of portable latrine 10 during use.

In FIG. 2, waste material W is shown beneath protective foam barrier 18 having foam barrier thickness T_{f}. As noted above, protective foam barrier 18 is formed of foam 16, which floats above waste material W and provides a visual, olfactory and physical splash barrier between aperture 28 and waste material W. Foam thickness T_{f} will vary depending on application. For example thickness T_{f} and may be as little as 2 inches, 3 inches or 5 inches, and may be as much as 8 inches, 12 inches or more, or may be any thickness within any range defined by the foregoing values.

For shorter desired foam barrier durations and/or light latrine use, a relatively small thickness T_{f} is sufficient. For example, a foam thickness T_{f} of 3 inches is sufficient to provide protective foam barrier 18 with a thorough visual and olfactory barrier for a relatively short amount of time under light to moderate use, i.e., 12 to 24 hours with a few users per hour. For heavier use over a relatively short amount of time, a protective foam barrier 18 having a 4 to 5 inch thickness T_{f} of foam 16 is appropriate.

For longer desired foam barrier durations and/or heavier latrine use, a relatively greater thickness T_{f} is appropriate. For example, protective foam barrier 18 may have a thickness T_{f} of about 5 inches for a 4 day service in light use, or may have an 8 to 11 inch thickness for a 7 day service in light to moderate use. A still larger value for foam thickness T_{f} may be used for longer service periods. For example, testing has shown that an 11 to 12 inch thickness T_{f} of protective foam barrier 18 has an effective service life of up to 9 days when storage tank 12 is open to the surrounding atmosphere at 64° F., and an effective service life of up to 13 days when stored in storage tank 12 that is sealed or covered at 64° F.

When foam 16 is newly deposited in storage tank 12 (as described in detail below), foam 16 is “wet”, meaning a relatively large amount of liquid is contained within the matrix of bubbles that form foam 16. As time progresses, some of the liquid is drawn down, or “drained”, from the bubble matrix of foam 16 by gravity. This drained material forms as a liquid layer beneath protective foam barrier 18 (or mixes with existing liquid, such as waste material W, beneath barrier 18). As foam 16 thus becomes “drier”, the reparability of protective foam barrier 18 (discussed above) decreases. The time required for a given volume of foam 16 to release a given amount of liquid in this way may be referred to as the “drain time” of foam 16. In addition to reparability, the persistence of protective foam barrier 18 is a function of the foam drain time of foam 16.

Relatively dry (i.e., “drained”) foam will not act to seal a void created by material passing therethrough as quickly as a relatively wetter foam. However, in the exemplary embodiment discussed above, the overall thickness T_{f} of foam 16 in protective foam barrier 18 does not begin to decrease for about 36 hours after foam 16 is initially deposited in storage tank 12. After 36 hours, thickness T_{f} of foam 16 decreases slowly at first, and then decreases more rapidly as time progresses.

As described in detail below, foam 16 is created by pumping a liquid foaming composition through a distribution system that aerates the liquid into foam 16. The exemplary liquid foaming composition disclosed in U.S. Pat. No. 4,874,641, incorporated by reference above, may or may be used in its pure, undiluted form or may be diluted with water or other liquids. The concentration of the liquid foaming composition affects the persistence of foam 16, such that dilution of the liquid foaming composition may be controlled to yield a particular persistence characteristic of foam 16. For example, using an undiluted form of the above-mentioned liquid foaming composition to create foam 16 will yield a foam barrier 18 that is effective for about 3 weeks under normal use conditions. Diluting the liquid foaming composition with water in a 1:1 ration will shorten this persistence to about 4 days, while a 4:1 ratio of water to liquid foaming composition shortens the persistence to about 24 hours. Thus, by controlling the concentration of the liquid foaming composition, a user of the present system can strike an optimal balance between the rate of use of the liquid foaming composition and the service life needed from foam barrier 18.

Environmental conditions and frequency of use can be expected to have a relatively minor impact on the service life of protective foam barrier 18. For example, temperature and humidity may slightly increase or decrease the drain time of foam 16 and the related service life of protective foam barrier 18, in that foam 16 may remain “wetter” for longer in warm, humid environments. On the other hand, the water contained within foam 16 may freeze in cold temperatures. It is contemplated that the water in foam 16 may be mixed or replaced with another liquid having a low freezing temperature to prevent foam 16 from freezing in cold service environments.

Turning now to FIG. 3, foam 16 may also be used in other latrine arrangements, such as a permanent latrine 100 having subterranean storage tank 102. Latrine 100 includes toilet 14 surrounded by enclosure 104, such as a small shed or cabin housing toilet 14 and any users thereof. Enclosure 104 may house multiple toilets 14, such as in multi-user latrines commonly found in public parks. Storage tank 102 may be in fluid communication with one toilet 14 or with multiples of toilet 14. Riser pipe 106 may extend between subterranean storage tank 102 and toilet 14, as shown, or subterranean storage tank 102 may be directly connected to toilet 14 in permanent latrine 100.

As in portable latrine 10, permanent latrine 100 has foam 16 having thickness T_{f} floating on the top of waste material W disposed at the bottom of subterranean storage tank 102. However, unlike storage tank 12 of portable latrine 10, subterranean storage tank 102 of latrine 100 has an overall depth D₂ which is substantially greater than depth D₁ of storage tank 12. Thus, subterranean storage tank 102 can contain larger volumes of waste material W and greater thicknesses T_{f} of foam 16 to create protective foam barrier 18. Thus, protective foam barrier 18 is suitable for use in larger scale operations such as multi-user permanent latrines 100 having large subterranean storage tanks 102.

Moreover, because permanent latrine 100 is enclosed by enclosure 104, the olfactory barrier provided by protective foam barrier 18 remains a significant advantage over a similar latrine without such barrier (as discussed below). In addition, the visual barrier and splash-back protection (also discussed below) will provide benefits when subterranean storage tank 102 becomes sufficiently full with waste material W to bring waste material W near aperture 28 of toilet 14, such as within riser pipe 106.

Advantageously, protective foam barrier 18 provides an olfactory barrier between waste material W (FIGS. 2 and 3) and the atmosphere within portable latrines 10, 100. In addition, protective foam barrier 18 provides a visual barrier between a user of portable latrine 10 and waste material W, thereby contributing to a desirable overall sanitary appearance at the inside of portable latrine 10.

Also advantageously, protective foam barrier 18 protects the health of users of portable latrine 10 by protecting the user from waste material W and any attendant potential for the spread of bacteria and disease. Protective foam barrier minimizes exposure to pathogens in waste material W by providing a physical barrier to waste material W splashing back onto a user of portable latrine 10, such as when new waste material is deposited into storage tank 12. Any splashing which may occur at the interface of waste material W and protective foam barrier 18 will be absorbed by the bottom surface of protective foam barrier 18, and foam barrier 18 physically resists the splashing waste material W from passing entirely through foam barrier 18.

Similarly, any splashing waste material W will be prevented from passing through a void created by passage of newly deposited waste material through barrier 18, because foam 16 will quickly repair the void (as discussed above) and prevent splashed-back waste material from passing therethrough. Moreover, even when foam 16 is relatively dry and unable to quickly self-repair (i.e., near the end of the service life for protective foam barrier 18), the potential for waste material W splashing back on a user of portable latrines 10, 100 remains minimal because only the original path of newly deposited waste material through protective foam barrier 18 would be available as a path for waste material W to splash back toward aperture 28 of toilet 14. Meanwhile, the remainder of foam 16 adjacent to the void created by the newly deposited waste material remains intact and absorbs additional splashing of waste material W.

Yet another advantage of the present disclosure is the minimization of insects in and around portable latrines 10, 100, which can carry and distribute waste material W and any bacteria and disease contained therein. Protective foam barrier 18 controls insect populations near latrines 10, 100 by at least two methods. First, the reduction in odors emanating from storage tank 12 provided by protective foam barrier 18 (discussed above with respect to olfactory barrier properties of barrier 18) reduces the number of insects that will be attracted to such odors. Second, any insects who do attempt to access waste material W will become trapped in foam 16.

It is contemplated that foam 16 may include a scent and/or color to enhance the aesthetic or olfactory qualities of protective foam barrier 18. For example, alcohol based scents and dyes may be added to foam 16. Alcohol does not adversely affect the composition of foam 16. Any scent or color may be used as required or desired for a particular application.

### 2. Foam Distribution Apparatuses and Methods

Foam 16 is produced by pumping a liquid foaming composition through a flow controlling orifice at a predetermined flow rate, and injecting and mixing air with the liquid stream downstream of the liquid flow control orifice. Exemplary liquid foaming compositions and associated methods of producing foam 16 are disclosed in U.S. Pat. No. 4,874,641, filed Nov. 24, 1987, and incorporated by reference above.

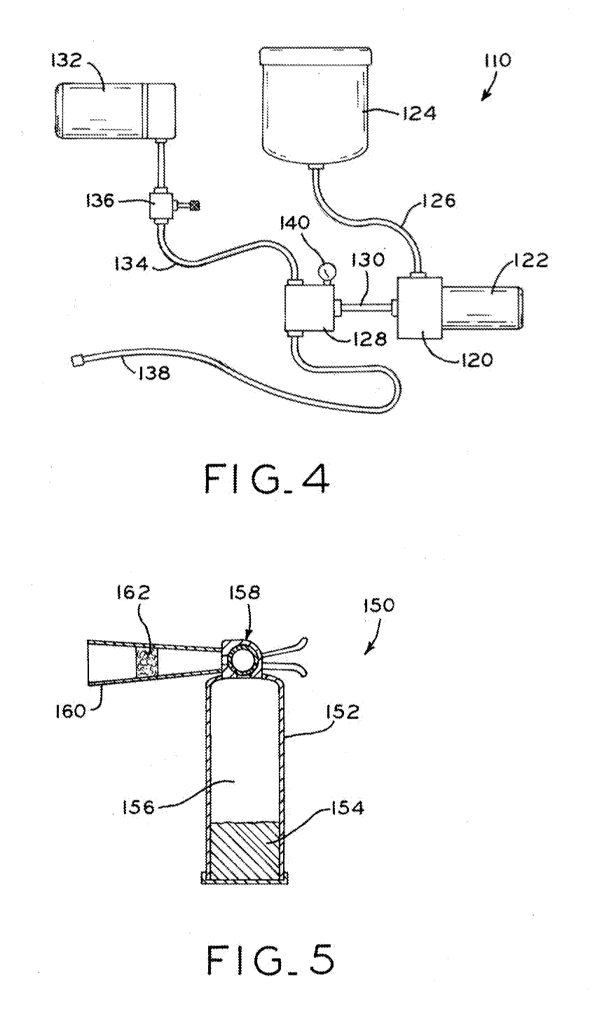

Referring now to FIG. 4, one exemplary system of producing foam 16 that can be mounted on a truck or other service vehicle, is shown schematically. Powered distribution system 110 includes pump 120, which is connected to motor 122 and receives a liquid form of foam 16 from fluid storage tank 124 via pump intake hose 126. Pump 120 pressurizes fluid from fluid holding tank 124 and delivers the pressurized fluid to manifold 128 via pump output hose 130. Pressurized air from compressor 132 is also delivered to manifold 128 via compressor hose 134, which includes a check valve 136 to prevent any backflow of pressurized material from manifold 128 to compressor 132. Manifold 128 mixes the pressurized fluid with the pressurized air, which creates foam 16. Manifold 128 delivers foam 16 to foam discharge hose 138, which is used to distribute foam 16 to a desired receptacle, such as storage tanks 12, 102.

Optionally, manifold 128 may include gauge 140 to monitor the fluid/air mixture pressure within manifold 128. Powered distribution system 110 may be mounted to a vehicle, as noted above, and powered by the vehicle power source. Alternatively, powered distribution system 110 may be permanently mounted at a service site, such as a public park outhouse or latrine facility.

One exemplary foam distribution and dispersion unit is the Odin® PAK-1000 system available from Odin Foam Products of Toledo, Oreg., which is a division of Darley.com (“Odin” is a registered trademark of W.S. Darley & Co. of Melrose Park, Ill.).

Referring now to FIG. 5, another exemplary system for distribution of foam 16 is hand-held distribution system 150. Portable distribution system 150 includes a dispersion tank 152 capable of containing pressurized fluids and/or gases. Dispersion tank 152 contains a liquefied version 154 of foam 16, together with compressed air 156. Nozzle 158 is adapted to receive compressed air 156 and liquefied foam 154, and to mix liquid 154 and air 156 to create foam 16. This mixing of liquefied foam 154 and air 156 may be accomplished in a conventional manner, well known in the art of fire extinguishers and other foam dispersal devices, for example. Discharge funnel 160 is connected to nozzle 158 to direct foam 16 along a desired path. Disposed within discharge funnel 160 is mesh baffle 162, which further agitates the foamed liquid/air mixture flowing from nozzle 158 to further agitate foam 16 as it flows from portable distribution system 150.

Portable distribution system 150 may be used for applications where the use of powered distribution 110 may be impractical, such as in remote locations or in locations which are not located near a road or power source. Portable distribution system 150 may be sized to be easily carried by hand, while providing sufficient quantities of foam 16 to form a protective foam barrier 18 of sufficient thickness for a given storage tank application.

In use, distribution systems 110, 150 are employed to service one or more latrines on-site. For example, latrines 10, 100 may receive an application of foam barrier 18 after each routine maintenance and cleaning procedure. In this method of application, foam 16 is sprayed or otherwise deposited into the empty storage tanks 12, 102 to a desired thickness T_{f} after draining and/or pumping waste material W out of storage tanks 12, 102. Upon subsequent use of toilet 14, a new layer of waste material W will form under protective foam barrier 18, which in turn will provide a sensory barrier between the user of latrines 10, 100 and waste material W as described herein.

Alternatively or additionally, foam 16 may be applied to storage tanks 12, 102 between cleaning procedures. For example, distribution systems 110, 150 may be used to spray or otherwise deposit foam 16 onto an existing layer of waste material W to create protective foam barrier 18. Upon subsequent use of toilet 14, waste material W will simply become thicker underneath protective foam barrier 18, while foam barrier elevates within storage tanks 12, 102 and continues to provide a sensory barrier between the user of latrines 10, 100 and waste material W.

Further, additional foam 16 may be added to an existing protective foam barrier 18 to increase thickness T_{f} and, concomitantly, the service life of protective foam barrier 18 (as described above). Advantageously, the addition of fresh, “wet” foam 16 to a partially-drained protective foam barrier 18 serves to partially replenish the pre-existing protective foam barrier 18, because liquid draining from the additional foam 16 increases the wetness of the partially-drained, drier portion of foam barrier 18. Alternatively, water may be misted onto foam barrier 18 to keep foam 16 wet and thereby extend its service life.

Advantageously, “stacking” a new layer of foam 16 on an existing, older layer delays the need for a full drain-and-clean service of latrine storage tanks 12, 102 while retaining the odor-control and splash-back mitigation benefits described above. Also, because liquid disinfectant need not be added to storage tank 12 prior to use, additional volume is made available in storage tank 12 for accumulation of waste material W. This additional available volume can further lengthen service intervals.

The additional foam may be added by either of distribution systems 110, 150, for example. In another embodiment, an automatic foam recharging system may be provided to add to the existing foam barrier 18 as needed. Such a recharging system may include a foam nozzle (similar to the foam nozzle provided with foam discharge hose 138 of distribution system 110, for example) oriented toward storage tank 12, 102. A timer may record the amount of elapsed time since the foam barrier 18 was initially established and/or recharged, or a means for registering the present upper level of foam barrier 18 may be provided. When the upper level or foam barrier 18 drops to a predetermined low point, and/or when a certain amount of time has elapsed, the automatic foam recharging system activates and sprays a new layer of foam 16 upon the existing foam barrier 18.

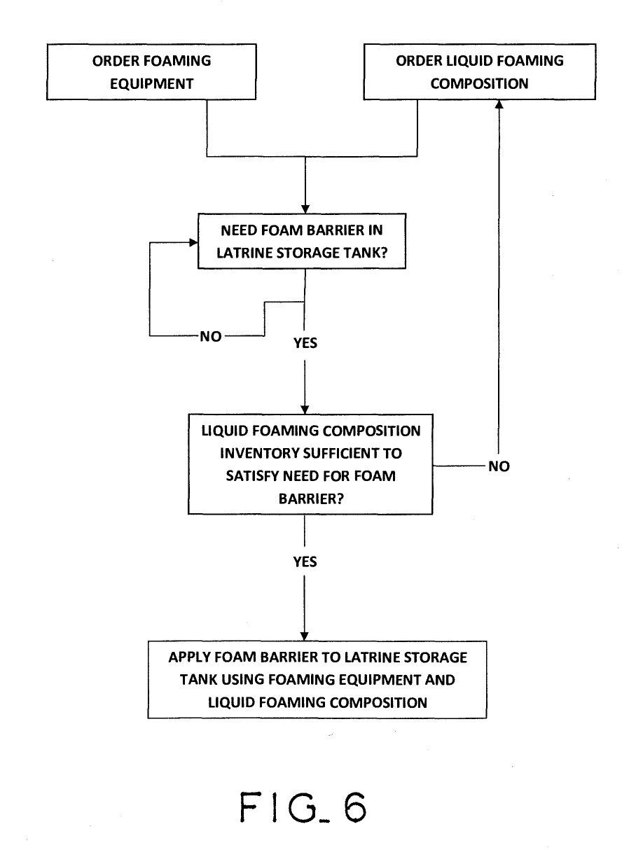

Advantageously, an existing service site maintenance crew can create and maintain foam barrier 18 with a minimum of investment and training. Referring to FIG. 6, the maintenance crew begins by purchasing its own distribution systems, such as distribution systems 110, 150, and ordering the liquid foaming composition described herein from a central distributor. The foaming equipment is a one-time purchase, which can be made from the same central distributor, or from a separate specialized vendor of foaming equipment. With the equipment and liquid foaming composition on hand, the maintenance crew can iteratively assess whether any latrine storage tanks (i.e., storage tanks 12, 102) are in need of foam barrier 18. If a need is identified, the crew next assesses whether the inventory of liquid foaming composition on hand is sufficient to satisfy the identified need, and orders more liquid foaming composition from the central distributor as needed. Once inventory concerns are addressed, the liquid foaming composition is processed into foam 16 to create foam barrier 18 in the service site latrines. Advantageously, the light weight of foam barrier 18 allows for long-lasting protection for a given amount of liquid foaming composition. Transport of the liquid foaming composition is therefore substantially less expensive and energy-intensive than transport for a comparable amount of disinfectant material delivered to a storage tank 12 in liquid form (as described above).

An on-site crew using the method illustrated in FIG. 6 therefore has the freedom to apply foam 16 to the site's latrines only when necessary. For example, the crew may be part of a construction job site with portable latrines 10, and may apply foam 16 to the portable latrines 10 in the morning before work begins, thereby ensuring that foam barrier 18 will persist throughout the work day. This “just in time” business model for latrine storage tank service maximizes the effective service life of foam barrier 18, and obviates the logistical burdens and costs associated with employing a specialized service crew to establish and maintain foam barrier 18.

However, it is also contemplated that a portable latrine 10 may be charged with protective foam barrier 18 at a location remote from the ultimate service site, such as at a centralized service location. In an exemplary method, for example, a portable restroom operator may own, maintain and utilize distribution systems 110 and/or 150 to add foam 16 to storage tank 12 to create protective foam barrier 18 therein. Portable latrine 10 may then be subsequently delivered to a service site with protective foam barrier 18 ready to isolate users from protective foam barrier 18. Foam barrier 18 may be recharged in the field as necessary, or portable latrine 10 may be shipped back to the remote location for cleaning of storage tank 12 and deposit of a new foam barrier 18. This “full service” business model may be appropriate for transitory customers or special events without a permanent staff.

Advantageously, portable latrine 10 maintains a minimal transport weight because foam barrier 18 is much lighter than a comparable amount of liquid disinfectant chemicals that might otherwise be added to storage tank 12 for sanitation and odor control. Further, foam 16 may be provided with a high level of lubricity to facilitate cleaning of storage tank 12.

While this invention has been described as having an exemplary design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method of isolating a user of a latrine from waste material contained in a latrine storage tank, the latrine having an interior sized to accommodate the user of the latrine, the method comprising:
forming a protective foam barrier within the latrine storage tank, the latrine storage tank in fluid communication with the interior of the latrine, the foam barrier providing at least one of an olfactory barrier, a visual barrier, and a physical barrier against splash back of waste material.

2. The method of claim 1, wherein said step of forming a protective foam barrier comprises depositing a layer of foam within the latrine storage tank, the layer of foam having a thickness of at least 2 inches.

3. The method of claim 1, wherein said step of forming a protective foam barrier comprises depositing a layer of foam within the latrine storage tank, the layer of foam having a thickness of up to 12 inches.

4. The method of claim 1, further comprising:
procuring a liquid foaming composition;
procuring a foam distribution system adapted to convert the liquid foaming composition into a foam,
wherein said step of forming a protective foam barrier comprises:
converting the liquid foaming composition into the foam with the foam distribution system; and;
depositing the foam into the latrine storage tank to form the protective foam barrier.

5. The method of claim 1, further comprising, after said step of forming a protective foam barrier:
allowing a lapse of time during which the protective foam barrier is allowed to at least partially drain; and
forming a second protective foam barrier within the latrine storage tank.

6. The method of claim 5, wherein the lapse of time is at least twelve hours.

7. The method of claim 5, wherein the lapse of time is up to three weeks.

8. The method of claim 1, wherein the latrine is at least partially enclosed.

9. A method of servicing a portable latrine, the method comprising:
providing a portable latrine having a latrine storage tank adapted to receive and store waste material;
forming a protective foam barrier within the latrine storage tank, the foam barrier providing at least one of an olfactory barrier, a visual barrier, and a physical barrier against splash back of waste material; and
delivering the portable latrine to a service site.

10. The method of claim 9, further comprising:
cleaning the latrine storage tank; and
forming a new protective foam barrier within the cleaned latrine storage tank.

11. The method of claim 9, wherein said step of delivering the portable latrine is performed after said step of forming a protective foam barrier.

12. The method of claim 9, wherein said step of delivering the portable latrine is performed before said step of forming a protective foam barrier.

13. The method of claim 9, further comprising, after said step of delivering the portable latrine:
allowing a lapse of time during which the protective foam barrier is allowed to at least partially drain; and
forming a second protective foam barrier within the latrine storage tank.

14. A latrine comprising:
a toilet;
a latrine storage tank in fluid communication with said toilet;
a protective foam barrier formed in said latrine storage tank, said protective foam barrier comprised of a plurality of self-repairing bubbles that are slidably oriented adjacent one another, such that said protective foam barrier allows waste material to pass therethrough while also providing at least one of an olfactory barrier, a visual barrier, and a physical barrier against splash back of waste material.

15. The latrine of claim 14, wherein said protective foam barrier has a thickness of at least 2 inches.

16. The latrine of claim 14, wherein said protective foam barrier has a thickness of up to 12 inches.

17. The latrine of claim 14, wherein said protective foam barrier provides said at least one of said olfactory barrier, said visual barrier, and said physical barrier against splash back of waste material for at least twelve hours after formation of said protective foam barrier.

18. The latrine of claim 14, wherein said protective foam barrier provides said at least one of said olfactory barrier, said visual barrier, and said physical barrier against splash back of waste material for up to three weeks after formation of said protective foam barrier.

19. The latrine of claim 14, wherein the latrine further comprises:
an enclosure substantially surrounding said latrine storage tank, whereby the latrine comprises a portable latrine.

20. The latrine of claim 14, wherein said latrine storage tank comprises a subterranean latrine storage tank, the latrine further comprising:
an enclosure in fluid communication with said subterranean latrine storage tank, whereby the latrine comprises a permanent latrine.
